(19) United States
(12) Patent Application Publication
(10) Pub. No.: US 2008/0274378 A1
(43) Pub. Date: Nov. 6, 2008

(54) MAGNETIC ALLOY FOR MAGNETIC RECORDING MEDIUM AND MAGNETIC RECORDING AND REPRODUCING APPARATUS USING THE MAGNETIC ALLOY

(75) Inventors: Takao Suzuki, Nagoya-shi (JP); Hiroshi Kanazawa, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignees: SHOWA DENKO K.K., Minato-ku (JP); TOYOTA SCHOOL FOUNDATION, Nagoya-shi (JP)

(21) Appl. No.: 12/112,581

(22) Filed: Apr. 30, 2008

Related U.S. Application Data
(63) Continuation-in-part of application No. 10/628,242, filed on Jul. 29, 2003.
(60) Provisional application No. 60/399,398, filed on Jul. 31, 2002.

(30) Foreign Application Priority Data
Jul. 29, 2002 (JP) 2002-219084

(51) Int. Cl. H01F 1/01; G11B 5/733

(52) U.S. Cl. 428/800; 148/300

(57) ABSTRACT

A magnetic alloy for a magnetic recording medium contains 40 to 60 at % of Pt and 60 to 40 at % of at least three species selected from the group consisting of Fe, Co, Mn and Cr as 3d transition metal elements. The magnetic alloy has a Co content of 10 to 0 at %, has an average of valence electron numbers in the 3d transition metal elements of 7.5 to 8.0 based on compositional proportions and has an order parameter S of 0.5 to 1 that is calculated from: S=[{F(002)²/F(001)²}×{L(002)/L(001)}×{(A(002)/A(001)}×{I(001)/I(002)}]^{1/2}, in which F (plane direction), L (plane direction), A (plane direction) and I (plane direction) represent structure factor, Lorentz factor, sorption factor and integrated intensity as measured through X-ray diffraction (θ/2θ) of the magnetic alloy in a corresponding plane direction, respectively.

### CROSS-REFERENCE TO RELATED APPLICATIONS

This application is a continuation-in-part application of our copending application Ser. No. 10/628,242 filed Jul. 29, 2003, which claims the benefit of U.S. Provisional Application No. 60/399,398, filed Jul. 31, 2002.

### BACKGROUND OF THE INVENTION

1. Field of the Invention

The present invention relates to a magnetic alloy for a magnetic recording medium and a magnetic recording and reproducing apparatus incorporating the magnetic alloy.

2. Description of the Prior Art

The recording density of a hard disk drive (HDD), which is a magnetic recording and reproducing apparatus, has increased at a rate of 60% or more per year, and this tendency is expected to continue. Therefore, magnetic recording heads and magnetic recording media which are suitable for attaining high recording density are now under development.

Most commercially available magnetic recording media employed in magnetic recording and reproducing apparatus are in-plane (longitudinal) magnetic recording media, in which easy-magnetization axes in magnetic films are oriented horizontally relative to their substrates. The term “easy-magnetization axis” as used herein refers to an axis along which the magnetization occurs easily. In the case of a Co-based alloy, the c axis of a Co hcp structure is the easy-magnetization axis.

When recording density is increased in the in-plane magnetic recording media of this nature, the volume of a magnetic layer per bit of the recording bits becomes excessively small, and the recording and reproducing characteristics of the medium may deteriorate for reasons of thermal instability. In addition, when recording density is increased, the effect of a demagnetization field at a recording bit boundary tends to cause an increase in medium noise.

In contrast, in a perpendicular magnetic recording medium in which easy-magnetization axes in a magnetic film are oriented generally perpendicular to a substrate, effects attributable to the demagnetization field in the recording bit are significant, and clear bit boundaries are formed, thus enabling noise reduction. Furthermore, even when recording density is increased, reduction in recording bit volume can be suppressed, and thus thermal stability can be enhanced. Therefore, in recently years, a perpendicular magnetic recording medium has become of keen interest, and a medium structure suitable for perpendicular magnetic recording has been proposed.

For example, Japanese Patent 2615847 discloses a perpendicular magnetic layer having a multilayer structure including a first layer formed of a magnetic material having a low Co content and a second layer formed of a magnetic material having a high Co content, the second layer being provided atop the first layer. Japanese Patent 3011918 discloses a technique similar to that disclosed in the above publication, in which an upper magnetic layer provided atop a lower magnetic layer which is close to a substrate is formed of a magnetic material having a Co content higher than that of the material of the lower magnetic layer and exhibiting high saturation magnetization (Ms) and magnetic anisotropy constant (Ku), to thereby enhance recording and reproduction characteristics, as well as thermal stability. Further, JP-A HEI 9-320847 discloses Fe—Pt and Co—Pt alloys possessing high magnetic anisotropy.

In response to demand for magnetic recording media of higher recording density, employment of a single-pole head exhibiting excellent ability to record data onto a perpendicular magnetic layer has been studied. In order to realize employment this head, there has been proposed a magnetic recording medium in which a layer formed of a soft magnetic material (called a “backing layer”) is provided between a substrate and a perpendicular magnetic layer serving as a recording layer, to thereby enhance efficiency in magnetic flux between the single-pole head and the medium.

However, the aforementioned magnetic recording medium in which a backing layer is simply added is not satisfactory in term of recording and reproduction characteristics, thermal stability, and recording resolution, and thus demand has arisen for a magnetic recording medium which is excellent in terms of these characteristics.

In order to enhance thermal stability, a magnetic alloy employed in a perpendicular magnetic layer is required to have a high genetic anisotropy constant (Ku). This is because the direction of the easy-magnetization axes must be oriented in the direction perpendicular to the film surface in order to enhance the recording and reproduction characteristics.

For this purpose, it is necessary to induce epitaxial growth allowing concordance between the lattice spacing in the under layer and the lattice spacing of the atoms in the magnetic layer and enabling the direction of the easy-magnetization axis to be oriented in the direction perpendicular to the film surface. In addition, the individual magnetic particles have to be magnetically separated for the purpose of assigning low noise to the recording and reproducing waveforms, and materials difficult of mutual mixture have to be selected for the element made to segregate on the boundary faces of magnetic particles and the magnetic element. Even in the case of using the Fe—Pt, Co—Pt alloys disclosed in JP-A HEI 9-320847, for example, the magnetic anisotropy thereof is not satisfactory and the magnetic separation of the magnetic particles forming the alloys is insufficient. Furthermore, since the Co-Pt alloy disclosed in the prior art mentioned above has a high Co content, the alloy used in a magnetic recording medium brings about low corrosion resistance of the magnetic recording medium. This is problematic. Moreover, demand has been arisen for developing a magnetic alloy for use in a magnetic recording medium refined in crystalline structure and high in coercivity in order to cope with higher recording density.

An object of the present invention is to provide a magnetic alloy for a magnetic recording medium, which has high thermal stability and is capable of coping with high recording density and provide a magnetic recording and reproducing apparatus having the recording density thereof enhanced exponentially.

### SUMMARY OF THE INVENTION

The present inventors have pursued a diligent study with a view to solving the problems mentioned above and consequently have achieved a magnetic alloy for a magnetic recording medium disclosed herein below and a magnetic recording and reproducing apparatus using this alloy for a magnetic recording medium.

The present invention provides a magnetic alloy for a magnetic recording medium, containing 40 to 60 at % of Pt and 60 to 40 at % of at least three species selected from the group consisting of Fe, Co, Mn and Cr as 3d transition metal elements, wherein the magnetic alloy has a Co content of 10 to 0 at %, has an average of valence electron numbers of the 3d transition metal elements of 7.5 to 8.0 as calculated based on the compositional proportions of the 3d transition metal elements and has an order parameter S of 0.5 to 1 that is calculated from: S=[{F(002)²/F(001)²}×{L(002)/L(001)}×{A(002)/A(001)}×{L(001)/L(002)}]^{1/2}, in which F (plane direction), L (plane direction), A (plane direction) and I (plane direction) represent structure factor, Lorentz factor, absorption factor and integrated intensity as measured through X-ray diffraction (θ/2θ) of the magnetic alloy in a corresponding plane direction, respectively. The magnetic alloy for a magnetic recording medium has a magnetic anisotropy constant Ku of 8×10⁵ J/m³ to 2×10⁷ J/m³.

The present invention further provides a magnetic recording and reproducing apparatus provided with a magnetic recording medium containing the magnetic alloy and a magnetic head for recording data in and reproducing the same from the magnetic recording medium.

The magnetic materials of the present invention suppress the migration of the crystal grains of Fe and Co in the magnetic alloy to provide excellent corrosion resistance even in an environment of high temperature and high humidity.

Use of the magnetic materials enables the provision of a permanent magnetic alloy refined in crystalline structure, high in coercivity and excellent in magnetic characteristic and the provision of a magnetic recording and reproducing apparatus high in thermal stability and exponentially high in recording density.

### DETAILED DESCRIPTION OF THE INVENTION

The magnetic alloy of the present invention contains 40 to 60 at % of Pt and 60 to 40 at % of at least three species selected from the group consisting of Fe, Co, Mn and Cr as 3d transition metal elements, wherein the magnetic alloy has a Co content of 10 to 0 at %, has an average of valence electron numbers in the 3d transition metal elements of 7.5 to 8.0 based on the compositional proportions and has a order parameter S of 0.5 to 1, preferably 0.8 to 1, that is calculated from Formula (1): S=[{F(002)²/F(001)²}×{L(002)/L(001)}×{A(002)/A(001)}×{I(001)/I(002)}]^{1/2}.

According to the present invention, a magnetic alloy having high Ku is obtained. When the magnetic alloy is employed in a perpendicular magnetic layer of a magnetic recording medium, lattice strain between the perpendicular magnetic layer and a soft magnetic layer can be reduced. When the perpendicular magnetic layer is used for a magnetic recording medium, it is made possible to obtain excellent corrosion resistance and provide a magnetic recording and reproducing apparatus high in practical utility.

The magnetic alloy of this invention may contain, in addition to Pt and 3d transition metal elements, an element which exerts an auxiliary effect on the magnetic alloy of this invention.

The term “3d transition metal elements” as used in the present specification specifically means and refers only to Cr, Mn, Fe, Co, Ni, and Cu. These elements are incorporated in the magnetic alloy of the present invention. The number of valence electrons in each of these 3d transition metal elements refers to the number of electrons in the 3d and 4s orbitals of the element. The valence electron numbers of Cr, Mn, Fe, Co, Ni, and Cu are 6, 7, 8, 9, 10 and 11, respectively. As auxiliary elements, elements which are generally considered to be 3d transition metal elements may additionally be incorporated in the alloys of the present invention, but these auxiliary elements are not within the meaning of the term “3d transition metal elements” as used in the present specification.

The magnetic alloy of the present invention contains as the 3d transition metal elements at lease three species selected from the group consisting of Fe, Co, Mn and Cr. Distinctly, the magnetic alloys available for this invention have at least three of Pt—Fe, Pt—Cr, Pt—Mn and Pt—Co alloys mixed therein. Since the melting points of these alloys differ from each other, even when being mixed in the magnetic alloy, the state of initial nucleation in each component varies. Therefore, it is possible to make microscopic the grain size of the crystals constituting the magnetic alloy having at least three alloys mixed therein and enhance the magnetic characteristics. When the compositional proportions of the 3d transition metal elements are varied in consideration of the number of valence electrons to thereby vary the lattice constant of the magnetic alloy, a lattice spacing which is most suitable for epitaxial growth can be obtained. In a magnetic recording medium, in order to magnetically segregate magnetic grains from one another, a nonmagnetic substance which does not form a complete solid solution together with a magnetic substance for forming a magnetic layer is incorporated into the magnetic layer, so that the nonmagnetic element is precipitated at the boundary between the magnetic grains. The effect obtained by this precipitation is determined by interaction between the elements constituting the magnetic alloy and the nonmagnetic element. In the magnetic alloy of the present invention, the total amount of the 3d transition metal elements is 60 to 40 at %, preferably 55 to 45 at %.

When the total amount of the 3d transition metal elements exceeds 60 at %, the structure of the magnetic alloy changes from L1₀ to L2₂, whereby the magnetic anisotropy constant Ku thereof is lowered. In contrast, when the total content of the 3d transition metal elements is less than 40 at %, Ku is lowered in accordance with an increase in the Pt content. In the present invention, when the magnetic alloy contains Co, the content of Co is made to be lower than 10 at % for the purpose of providing a magnetic alloy enhanced in corrosion resistance and high in practical utility.

In the magnetic alloy of this invention, the average number of valence electrons in the respective 3d transition metal elements as calculated on the basis of the compositional proportions of the 3d transition metal elements is 7.5 to 8.0, preferably 7.5 to 7.6. The average number of the valence electrons in the respective 3d transition metal elements is calculated as follows. For example, in the case of Pt₆₀Fe₂₀Ni₂₀ alloy (namely, an alloy containing 60 at % of Pt, 20 at % of Fe and 20 at % of Ni, the same convention applying hereinafter), the alloy contains Fe and Ni that are 3d transition metal elements at a ratio of 1:1. Thus, the average number of valence electrons is 9. The average number of valence electrons in the case of Pt₆₀Fe₂₀Co₂₀ alloy is 8.5, that in the case of Pt₆₀Fe₃₀Co₁₀ alloy is 8.25 and that in the case of Cr, Fe₃₆Pt₅₂ alloy is 7.5.

Although Cu and Ni are 3d transition metal elements that are not indispensable to the magnetic alloy of the present invention, they are used in calculating the average number of valence electrons.

In the magnetic alloy of the present invention, when the average number of valence electrons in the respective 3d transition metal elements as calculated on the basis of the compositional proportions of the elements is less than 7.5 or more than 8.0, high Ku value fails to be obtained. Moreover, the corrosion resistance of the magnetic alloy is degraded when the average number of valence electrons becomes larger than 8.0.

The magnetic alloy of this invention has the order parameter S calculated from Formula (1) of 0.5 to 1, preferably 0.8 to 1. No large value of Ku is obtained when the order parameter S becomes smaller than 0.5. The order parameter S is calculated by a method which is described below. The upper limit of the order parameter S is 1. The F (plane direction), L (plane direction), A (plane direction), and I (plane direction) in Formula (I) represent the structure factor, Lorentz factor, absorption factor and integration intensity as measured through X-ray diffractometry (ν/2θ) of the magnetic alloy in the corresponding plane directions, respectively. The values of atomic scattering factor, Lorentz factor and mass absorption coefficient (μ/ρ) that are actually used in the calculation of the order parameter S are shown in Table 1 below. These values have been determined using a Cu-K a ray as the X-ray source.

TABLE 1
Atomic scattering factor (f)

| hkl | f(Ptₕₖₗ) | f(Crₕₖₗ) | f(Mnₕₖₗ) | f(Feₕₖₗ) | f(Coₕₖₗ) | f(Niₕₖₗ) | f(Cuₕₖₗ) |
|---|---|---|---|---|---|---|---|
| 001 | 71.0 | 20.1 | 20.2 | 22.3 | 23.3 | 24.2 | 24.8 |
| 002 | 61.3 | 15.5 | 15.6 | 17.8 | 18.6 | 19.5 | 19.6 |

Lorentz factor (L)

| hkl | L(hkl) |
|---|---|
| 001 | 4.55 |
| 002 | 1.90 |

Mass absorption coefficient (μ/ρ) for each element

| Cr | Mn | Fe | Co | Ni | Cu | Pt |
|---|---|---|---|---|---|---|
| 252.3 | 284 | 304.4 | 338.6 | 48.83 | 52.7 | 198.2 |

The structure factor is represented by the following formulae:

F(001)=f{(3d transition metal element)₀₀₁}−f(Pt₀₀₁)

F(002)=f{(3d transition metal element)₀₀₂}+f(Pt₀₀₂)

wherein f denotes an atomic scattering factor. Then, f {(3d transition metal element)₀₀₁} and f {(3d transition metal element)₀₀₂} refer to the average values of atomic scattering factors relative to the 3d transition metal elements contained in the magnetic alloy. When Fe and Co are contained at a ratio of 2:1, for example, f {(3d transition metal element)₀₀₁} and f {(3d transition metal element)₀₀₂} are obtained from the following formulae:

f{(3d transition metal element)₀₀₁}={f(Fe₀₀₁)×2+f(Co₀₀₁)×1}/3

f{(3d transition metal element)₀₀₂}={f(Fe₀₀₂)×2+f(Co₀₀₂)×1}/3.

L (001) and L (002) are Lorentz factors, and are represented by the following formula: L (plane direction)=(1+cos² 2θ/sin 2θ). In the case of a perpendicular recording medium, the easy-magnetization axes must be oriented in the vertical direction. The Lorentz factors can be employed as the θ/2θ measurement values of a perpendicular recording medium. Since these values are almost the same between elements, the values shown in Table 1 are employed.

A (001) and A (002) are absorption factors and are represented by the following formula: A (plane direction)=1−exp(−2 μd/sin θ), wherein μ represents a linear absorption coefficient and d represents a film thickness (unit: cm). In the above calculation of A, since a change in θ value with different alloys has little effect on the alloy, θ=11.9 degrees was employed here.

The μ value of the alloy (μ_{Alloy}) is obtained by use of the mass absorption coefficient (μ/ρ) shown in Table 1, so as to reflect the mass ratio on the μ value as described below.

μ_{Alloy}=ρ_{Alloy}[w₁(μ/ρ)₁+w₂(μ/ρ)₂+ . . . ]

wherein μ_{Alloy}, ρ_{Alloy}, w₁, and (μ/ρ)₁ represent the linear absorption coefficient of the alloy, the density of the alloy, the mass % of one element (1) of the alloy, and the mass absorption coefficient of element (1) of the alloy, respectively, w₂ and (μ/ρ)₂ represent the mass % of a second element (2) of the alloy and the mass absorption coefficient of element (2) of the alloy, respectively, and so on.

The magnetic alloy of the present invention preferably has a magnetic anisotropy constant Ku of 8×10⁵ J/m³ to 2×10⁷ J/m³. When Ku falls in the above range, the magnetic alloy can be employed as a promising permanent magnet material. In addition, when the magnetic alloy is employed in a magnetic recording medium, the medium exhibits enhanced thermal stability.

The calculation of Ku utilizes the following procedure.

(1) A magnetic film 50 nm (500 Å) thick is deposited on an MgO single crystal substrate {plane direction (100)}.

(2) A torque curve is obtained by use of a torque magnetometer under application of a magnetic field of 10 kOe (1 Oe=about 79 A/m), 15 kOe, 20 kOe, 25 kOe, or 30 kOe. From these results, the magnetic torque under each external field can be estimated using Fourier series expansion by sin 2α value (wherein α represents an angle formed between the direction of the applied magnetic field and an easy-magnetization axis).

(3) The thus-obtained value is plotted against the inverse number of the applied magnetic field. Here, infinite limit of magnetic torque (Tmag) is defined using a straight line to y axis by the least squares method.

(4) Saturation magnetization (Ms) is obtained from a magnetization curve obtained by use of a vibrating sample magnetometer (VSM).

(5) Ku is calculated by use of the following formula: Ku=2πMs²+Tmag. In the aforementioned calculation procedure, when the intensity of the applied magnetic field is increased; i.e., when hard-magnetization axes are oriented in a magnetization direction, and more accurate measurement is performed, the Tmag value tends to become large, and the thus-obtained Ku value is considered to become lower than the real value.

In a magnetic recording medium that has a soft magnetic layer, a perpendicular magnetic layer and a protecting layer deposited on a substrate, the magnetic alloy of this invention is preferably used as the perpendicular magnetic layer. When the perpendicular magnetic layer is formed of the magnetic alloy of the present invention, the resultant magnetic recording medium exhibits enhanced thermal stability.

The magnetic recording medium employing the magnetic alloy of the present invention preferably constitutes a magnetic recording and reproducing apparatus together with a magnetic head for recording data onto the medium and reproducing the data therefrom. The magnetic recording and reproducing apparatus incorporating the magnetic recording medium using the magic alloy of the sent invention exhibits enhanced thermal stability and considerably high recording density.

### EXAMPLES 1 TO 8 AND COMPARATIVE EXAMPLES 1 TO 10

A magnetic film was deposited on the surface of an MgO single crystal substrate {plane direction (100)} by use of an electron beam evaporation apparatus. The temperature of the substrate was regulated to 500° C. and the thickness of the film to 500 Å.

Magnetic characteristics and corrosion resistance of the magnetic film thus formed were measured. The order parameter S was measured through X-ray diffractometry (θ/2θ). The magnetic anisotropy constant Ku was calculated by use of a torque magnetometer (applied maximum magnetic field: 30 kOe). The evaluation of the corrosion resistance was implemented by depositing a carbon film 50 Å thick by the CVD method on the surface of a given magnetic film, leaving the substrate to stand for 48 hours in an environment measuring 80° C. in temperature and 80% in humidity, dropping 100μ liters each of an aqueous 3% nitric acid solution at ten portions on the surface of the substrate, leaving the drops of the solution to stand for one hour, then recovering the solution drops, and subjecting these solution drops to quantitative analysis to find the contents of iron and cobalt therein. The composition of the magnetic films (magnetic alloys) and measurement results are shown in Table 2 below.

TABLE 2

| | | | | | | | | | | Average | | | | | | |
|---|---|---|---|---|---|---|---|---|---|---|---|---|---|---|---|---|
| | | | | | | | | | | Number | | | | Amounts of | | |
| | | | | | | | | | | of | | | | Fe and Co | | |
| | | Contents of component elements (at %) | | | | | | | | Valence | | Ku | Hc | extracted (ng) | | |
| | Composition | Pt | Cr | Mn | Fe | Co | Ni | Cu | Others | Electrons | S | (J/m³) | (Oe) | Fe | Co | Fe + Co |
| C.E.* 1 | Cr12Fe36Pt52 | 52 | 12 | | 36 | | | | | 7.50 | 0.85 | 2.1 × 10⁶ | 530 | 0.14 | 0.00 | 0.14 |
| C.E. 2 | Fe25Co30Pt45 | 45 | | | 25 | 30 | | | | 8.55 | 0.65 | 2.4 × 10⁶ | 310 | 0.78 | 0.69 | 1.47 |
| C.E. 3 | Fe38Co10Ni5Pt47 | 47 | | | 38 | 10 | 5 | | | 8.38 | 0.70 | 3.8 × 10⁶ | 250 | 0.85 | 0.23 | 1.08 |
| C.E. 4 | Mn4Fe32Co10Cu4Pt50 | 50 | — | 4 | 32 | 10 | | 4 | | 8.36 | 0.88 | 1.6 × 10⁶ | 400 | 0.22 | 0.11 | 0.33 |
| C.E. 5 | Ni50Pt50 | 50 | | | | | 50 | | | 10.0 | 0.70 | 0 | 0 | 0.00 | 0.00 | 0.00 |
| C.E. 6 | Cr25Fe25Pt50 | 50 | 25 | | 25 | | | | | 7.00 | 0.63 | 0 | 0 | 0.09 | 0.00 | 0.09 |
| C.E. 7 | Co25Ni25Pt50 | 50 | | | | 25 | 25 | | | 9.50 | 0.60 | 3.0 × 10⁵ | 150 | 0.00 | 0.83 | 0.83 |
| C.E. 8 | Cr12Fe38Pt50 | 50 | 12 | | 38 | | | | | 7.52 | 0.40 | 3.2 × 10⁵ | 380 | 0.13 | 0.00 | 0.13 |
| C.E. 9 | Fe28Co12Pt45Mn15 | 45 | | 15 | 28 | 12 | | | | 7.95 | 0.62 | 2.1 × 10⁶ | 350 | 0.11 | 0.43 | 0.54 |
| C.E. 10 | Fe28Co12Pt45Cr15 | 45 | 15 | | 28 | 12 | | | | 7.70 | 0.64 | 2.3 × 10⁶ | 300 | 0.08 | 0.06 | 0.14 |
| Ex. 1 | Cr5Mn16Fe30Pt49 | 49 | 3 | 18 | 30 | | | | | 7.53 | 0.63 | 1.5 × 10⁶ | 4825 | 0.21 | 0.00 | 0.21 |
| Ex. 2 | Cr3Mn17Fe25Co3Pt52 | 52 | 3 | 17 | 25 | 3 | | | | 7.58 | 0.84 | 2.2 × 10⁶ | 2670 | 0.14 | 0.01 | 0.15 |
| Ex. 3 | Cr6Mn5Fe40Co5Ti2Pt42 | 42 | 6 | 5 | 40 | 5 | | | 2(Ti) | 7.79 | 0.81 | 2.9 × 10⁶ | 6390 | 0.28 | 0.01 | 0.29 |
| Ex. 4 | Cr3Mn12Fe35Ni2V1Pt47 | 47 | 3 | 12 | 35 | | 2 | | 1(V) | 7.73 | 0.83 | 3.0 × 10⁶ | 3620 | 0.21 | 0.00 | 0.21 |
| Ex. 5 | Cr10Fe37Co3Ru4Pt46 | 46 | 10 | | 37 | 3 | | | 4(Ru) | 7.66 | 0.79 | 2.0 × 10⁶ | 4510 | 0.20 | 0.00 | 0.20 |
| Ex. 6 | Cr5Mn10Fe30Co5Cu2Pt48 | 48 | 5 | 10 | 30 | 5 | | 2 | | 7.83 | 0.83 | 1.9 × 10⁶ | 2970 | 0.18 | 0.01 | 0.19 |
| Ex. 7 | Cr4Mn11Fe25Co10Mo1Pt49 | 49 | 4 | 11 | 25 | 10 | | | 1(Mo) | 7.82 | 0.80 | 2.4 × 10⁶ | 1650 | 0.15 | 0.09 | 0.24 |
| Ex. 8 | Cr5Mn5Fe35Co5Nb2Pt48 | 48 | 5 | 5 | 35 | 5 | | | 2(Nb) | 7.80 | 0.82 | 1.7 × 10⁶ | 3280 | 0.24 | 0.02 | 0.26 |

C.E. Comparative Example

Employment of the magnetic alloy of the present invention can provide a permanent magnetic alloy refined in crystalline structure, high in coercivity and excellent in magnetic characteristics as well as a magnetic recording and reproducing apparatus exhibiting enhanced thermal stability and considerably high recording density. Particularly, the magnetic material of this invention is capable of suppressing the migration of Fe and Co crystal grains and exhibiting excellent corrosion resistance even in an environment of high temperature and high humidity.

As is clear from Table 2 above, the addition of Cr to the magnetic alloy of the present invention has an effect of exhibiting excellent corrosion resistance and the addition of Cr and Mn attains enhancement of the coercivity.

While the invention has been described in detail and with reference to specific embodiments thereof, it will be apparent to one skilled in the art that various changes and modifications can be made therein without departing from the spirit and scope thereof.

What is claimed is:

1. A magnetic alloy for a magnetic recording medium, containing 40 to 60 at % of Pt and 60 to 40 at % of at least three species selected from the group consisting of Fe, Co, Mn and Cr as 3d transition metal elements, wherein the magnetic alloy has a Co content of 10 to 0 at %, has an average of valence electron numbers of the 3d transition metal elements of 7.5 to 8.0 as calculated based on the compositional proportions of the 3d transition metal elements and has an order parameter S of 0.5 to 1 that is calculated from: S=[{F (002)²/F (001)²}×{L(002)/L(001)}×{A(002)/A(001)}×{I(001)/I(002)}]^{1/2}, in which F (plane direction), L (plane direction, A (plane direction) and I (plane direction) represent structure factor, Lorentz factor, absorption factor and integrated intensity as measured through X-ray diffraction (θ/2θ) of the magnetic alloy in a corresponding plane direction, respectively.

2. A magnetic alloy for a magnetic recording medium according to claim 1, which has a magnetic anisotropy constant Ku of 8×10⁵ μm³ to 2×10⁷ J/m³.

3. A magnetic recording and reproducing apparatus provided with a magnetic recording medium containing the magnetic alloy according to claim 1 and a magnetic head for recording data onto the medium and reproducing the data therefrom.

4. A magnetic recording and reproducing apparatus provided with a magnetic recording medium containing the magnetic alloy according to claim 2 and a magnetic head for recording data onto the medium and reproducing the data therefrom.
